(19) United States
(12) Patent Application Publication
(10) Pub. No.: US 2025/0233174 A1
(43) Pub. Date: Jul. 17, 2025

(54) Apparatus And Method For A Hydrogen Powered Generator With High Capacity Hydrogen Storage Devices

(71) Applicant: Prometheus Energy Group, LLC, St. Charles, IL (US)

(72) Inventor: Nicolas Kernene, St. Charles, IL (US)

(21) Appl. No.: 19/098,879

(22) Filed: Apr. 2, 2025

Related U.S. Application Data
(63) Continuation of application No. PCT/US2023/075458, filed on Sep. 28, 2023.
(60) Provisional application No. 63/378,125, filed on Oct. 3, 2022.

(51) Int. Cl. H01M 8/04082

(52) U.S. Cl. CPC H01M 8/04216

(57) ABSTRACT

A hydrogen powered generator includes at least one fuel cell, a power converter that receives a raw power from the at least one fuel cell and outputs a converted power; and a hydrogen storage assembly that supplies hydrogen to the at least one fuel cell. In one instance, the hydrogen storage assembly comprises a first hydrogen storage unit and a second hydrogen storage unit which each comprise a torus containing a metal alloy material that absorbs and releases hydrogen gas. In another instance, the hydrogen storage assembly comprises a first hydrogen storage unit and a second hydrogen storage unit which each comprise a storage volume defined by: an outer cylinder, an inner cylinder, a top flange attached to the inner cylinder, and a bottom flange attached to the inner cylinder, wherein the storage volume is configured to contain a metal alloy material that absorbs and releases hydrogen gas.

### RELATED APPLICATIONS

The present application is a continuation application of and claims priority to PCT Patent Application No. PCT/US2023/075458 filed Sep. 28, 2023, which claims the benefit of U.S. Provisional Patent Application No. 63/378, 125 filed Oct. 3, 2022. The entire content of the foregoing applications is incorporated herein by reference.

### TECHNICAL FIELD

Embodiments of the technology relate generally to a generator comprising a power converter, at least one fuel cell, and a hydrogen storage assembly.

### BACKGROUND

Hydrogen is the object of significant research as an alternate fuel source to fossil fuels. Hydrogen is attractive because (i) it can be produced from many diverse energy sources, (ii) it has a high energy content by weight (about three times more than gasoline) and (iii) it has a zero-carbon emission footprint—the by-products of hydrogen combustion being oxygen and water.

However, hydrogen has physical characteristics that make it difficult to store in large quantities without taking up a significant amount of space. Despite hydrogen's high energy content by weight, hydrogen has a low energy content by volume. This makes hydrogen difficult to store, particularly within the size and weight constraints of a vehicle, for example. Another major obstacle is hydrogen's flammability and the concomitant safe storage thereof.

Known hydrogen storage technologies directed to high pressure tanks with compressed hydrogen gas and/or cryogenic liquid hydrogen storage have shortcomings because the risk of explosion still exists. These approaches require pressurized containers that are heavy and also require high energy input—features that detract from commercial viability.

Metal alloy hydrogen storage is based on materials capable of absorbing and releasing the hydrogen. Metal alloy hydrogen storage provides high energy content by volume, reduces the risk of explosion, and eliminates the need for high pressure tanks and insulation devices. Examples of hydrogen storage devices using metal alloys are described in U.S. Pat. No. 9,841,147 to Kernene.

Leveraging the benefits of hydrogen requires systems that facilitate broader use of hydrogen as an energy source. Portable generators that are powered by hydrogen represent one type of system that can facilitate broader use of hydrogen as an energy source.

### SUMMARY

The present disclosure is generally directed to a generator powered by hydrogen gas. In one example embodiment, the hydrogen powered generator can comprise at least one fuel cell; a power converter that receives a raw power from the at least one fuel cell and outputs a converted power; and a hydrogen storage assembly that supplies hydrogen to the at least one fuel cell, the hydrogen storage assembly comprising a first hydrogen storage unit in fluid communication with the at least one fuel cell and a second hydrogen storage unit in fluid communication with the at least one fuel cell. The first hydrogen storage unit and the second hydrogen storage unit can comprise a torus containing a metal alloy material that absorbs and releases hydrogen gas.

In another example embodiment, the present disclosure is directed to a generator powered by hydrogen gas. In one example embodiment, the hydrogen powered generator can comprise at least one fuel cell; a power converter that receives a raw power from the at least one fuel cell and outputs a converted power; and a hydrogen storage assembly that supplies hydrogen to the at least one fuel cell, the hydrogen storage assembly comprising a first hydrogen storage unit in fluid communication with the at least one fuel cell and a second hydrogen storage unit in fluid communication with the at least one fuel cell. The first hydrogen storage unit and the second hydrogen storage unit can comprise a storage volume defined by: an outer cylinder, an inner cylinder, a top flange attached to the inner cylinder, and a bottom flange attached to the inner cylinder, wherein the storage volume is configured to contain a metal alloy material that absorbs and releases hydrogen gas.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of hydrogen powered generators and therefore are not to be considered limiting of the scope of this disclosure. The principles illustrated in the example embodiments of the drawings can be applied to alternate methods and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 is a block diagram illustrating a generator and a portable power distribution box in accordance with the prior art.

FIG. 2 is a block diagram of a hydrogen powered generator in accordance with the example embodiments of the disclosure.

FIGS. 3, 4, and 5 provide various views of a hydrogen powered generator in accordance with an example embodiment of the disclosure.

FIGS. 6 and 7 provide front and top views of a hydrogen powered generator in accordance with another example embodiment of the disclosure.

FIGS. 8 and 9 provide front and top views of a hydrogen powered generator in accordance with yet another example embodiment of the disclosure.

FIG. 10 illustrates the exterior of a hydrogen storage unit in accordance with an example embodiment of the disclosure.

FIG. 11 is an exploded view illustrating components of the hydrogen storage unit of FIG. 10 in accordance with an example embodiment of the disclosure.

FIG. 12 illustrates the exterior of a hydrogen storage unit in accordance with another example embodiment of the disclosure.

FIG. 13 is an exploded view illustrating components of the hydrogen storage unit of FIG. 12 in accordance with an example embodiment of the disclosure.

FIG. 14 illustrates the exterior of a hydrogen storage unit in accordance with yet another example embodiment of the disclosure.

FIG. 15 illustrates components of a coupler in accordance with the hydrogen storage unit of FIG. 14 in accordance with an example embodiment of the disclosure.

### DETAILED DESCRIPTION OF EXAMPLE EMBODIMENTS

The example embodiments discussed herein are directed to a generator that is powered by hydrogen. Specifically, hydrogen is absorbed by and stored in metal alloy material within multiple hydrogen storage units. The multiple hydrogen storage units are stored within the generator and supply hydrogen to one or more fuel cells when needed. The fuel cells provide power to a power converter that can convert and output power at a desired voltage, amperage, and phase. The generator can be used for primary power or can be stored for extended lengths of time and provide back-up power when needed. The flexibility of the hydrogen powered generator provides several advantages.

Prior art generators typically are paired with a portable distribution box to provide power at the desired voltage, amperage, and phase as needed for a particular application. However, prior art generators and distribution boxes typically are not configurable. In other words, if particular equipment requires a different form of power than provided by the distribution box on hand, then one is required to obtain another distribution box for coupling with the generator. In contrast, the hydrogen powered generator described herein has an integrated power converter that accommodates swappable blades. Each of the blades can be configured to provide power having a particular voltage, current, and phase, thereby making the power output from the hydrogen powered generator configurable.

The design of the hydrogen powered generator allows the hydrogen storage units to be easily recharged with hydrogen when the stored hydrogen has been depleted. The hydrogen storage units contain metal alloy material and the hydrogen gas is adsorbed and absorbed by the metal alloy material producing a metal hydride. The metal hydride stored within the hydrogen storage units is very stable allowing it to be easily transported and stored for several years with very little hydrogen loss. The shape of the hydrogen storage unit is optimized to facilitate heat transfer during charging and discharging of the hydrogen storage unit with hydrogen and to facilitate the flow of hydrogen into and out of the hydrogen storage unit in order to maximize the quantity of hydrogen stored within the volume of the unit. The hydrogen storage unit can be easily combined with multiple hydrogen storage units into an assembly. The configuration of the hydrogen storage unit facilitates the use of hydrogen in the generators described herein. As will be described further in the following examples, the methods and apparatus described herein improve upon prior approaches to using hydrogen as a power source.

While the example embodiments described herein are directed to generators powered by stored hydrogen gas, it should be understood that the generators described herein also can be powered using other types of gases. Examples of gases that can be stored in the storage units to power the generators described herein include hydrogen, methane, ethane, propane, butane, hythane (hydrogen/methane), and combinations of the foregoing.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

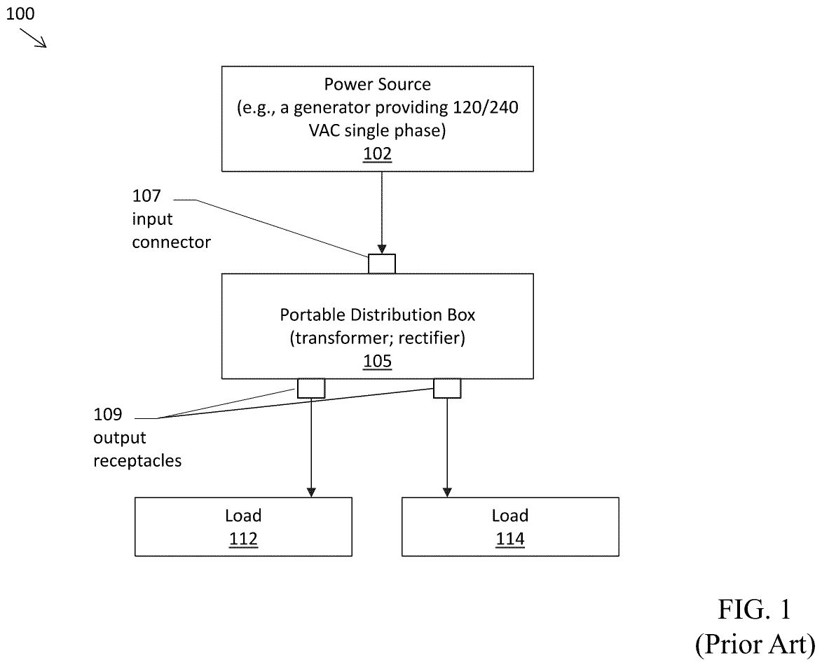

Referring now to FIG. 1, an example of a prior art system is illustrated. Prior art system 100 includes a power source such as a generator 102 that provides power generated by an internal combustion engine that burns a fuel such as gasoline or propane. The generator 102 can have one or more output receptacles providing an output power, such as 120 VAC or 240 VAC. The generator 102 is coupled with a portable distribution box 105. The portable distribution box 105 has an input connector 107 to receive input power from the generator 102. The portable distribution box 105 also includes one or more power converters, such as a transformer, buck converter, or rectifier, to modify the input power and provide an output power at output receptacles 109. The output power can be provided to load 112 and load 114.

As illustrated in FIG. 1, one of the shortcomings of the prior art system 100 is that a generator must be coupled with a portable distribution box to adapt the generator's power to the voltage, amperage, and phase requirements of the equipment that receives power. The power requirements of equipment at a site can vary widely. If the appropriate distribution box is not available, another distribution box must be obtained that provides power in the required form. In contrast, as will be described further below, the hydrogen powered generators described herein provide a single system that integrates a clean power source with a power converter. The clean power provided by hydrogen and fuel cells can be safely stored for long periods of time. Additionally, the storage assembly of the hydrogen powered generator can be easily recharged with additional hydrogen when the stored hydrogen is depleted. Additional advantages of the hydrogen powered generator will be apparent in the following description of the example embodiments.

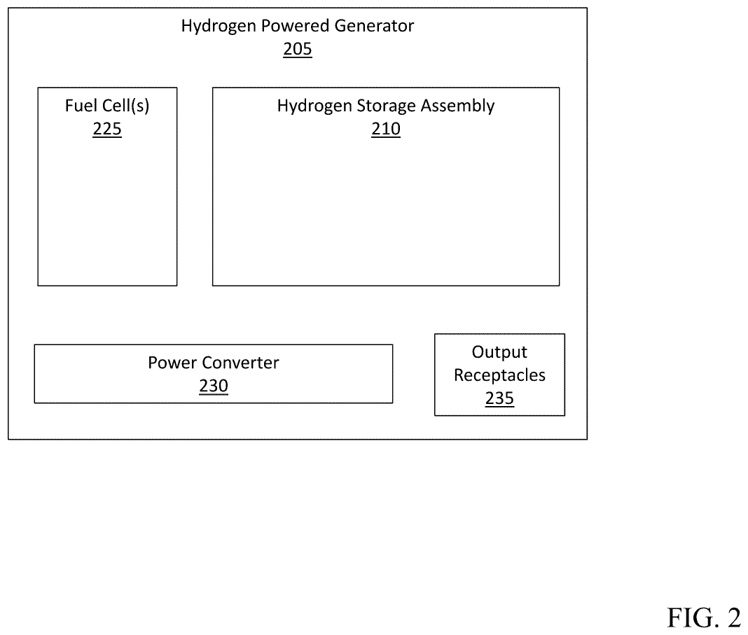

Referring now to FIG. 2, a block diagram is provided illustrating the primary components of a hydrogen powered generator 205 in accordance with an example embodiment of this disclosure. The hydrogen powered generator 205 includes a hydrogen storage assembly 210 that stores hydrogen to be used in one or more fuel cells 225. As referenced previously and as described further below, the hydrogen storage assembly 210 can comprise one or more hydrogen storage units containing metal alloy material that absorbs and adsorbs gaseous hydrogen forming a metal hydride. The metal hydride is a stable composition that can be safely stored for months or years. When power is needed, the hydrogen can be released from the hydrogen storage units and can be used by the one or more fuel cells 225 to generate electrical power.

The fuel cells 225 typically output DC power. The hydrogen powered generator 205 includes one or more power converters 230 to modify the power output by the fuel cells 225 to a particular voltage, current, and phase. The power converters can be one or more blades that slide into and out of the hydrogen powered generator. Each blade can comprise the electrical components, such as one or more of transformers, inverters, and boost or buck converters, needed to convert the power from the fuel cells as well as a metering component for measuring the amount of power delivered. In some cases, the blades can be similar to a backplane comprising slots for power conversion components as well as one or more processors for intelligently controlling the power conversion and delivery. The power converter 230 can be configured so that blades can easily slide into and out of the power converter to meet various power requirements. Once the converters modify the power, an output power is delivered to one or more output receptacles 235.

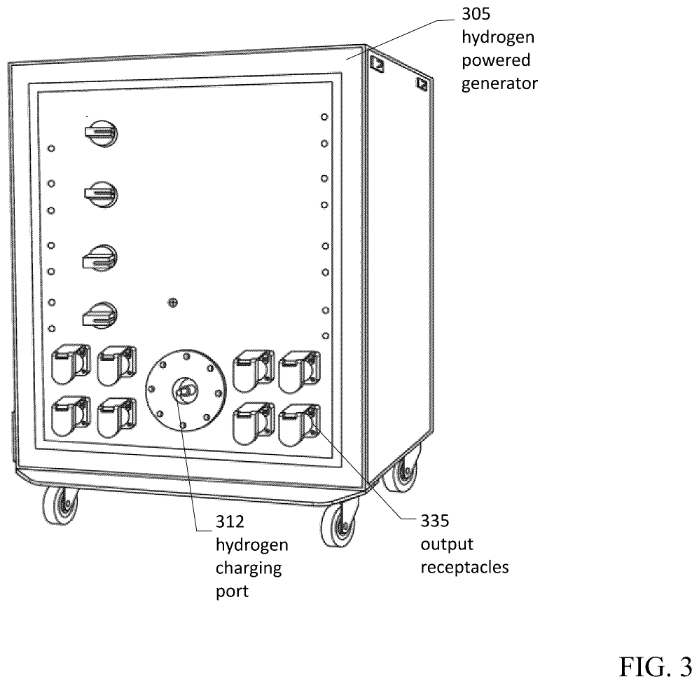

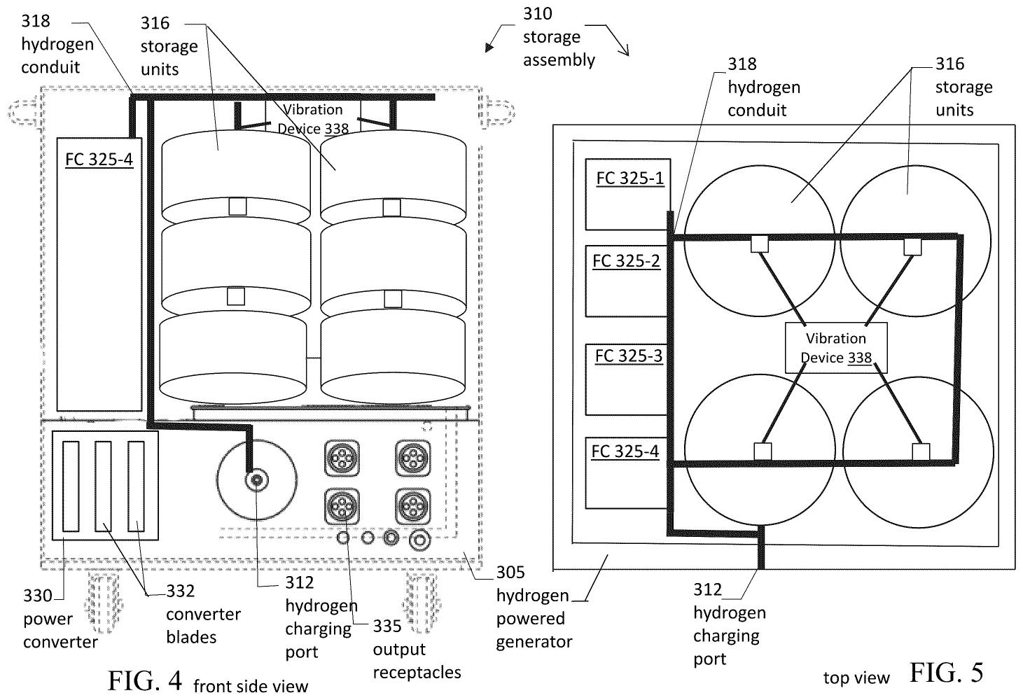

Referring now to FIGS. 3, 4, and 5, another example embodiment of a hydrogen powered generator is illustrated. FIG. 3 provides a front side view of the exterior of the example hydrogen powered generator 305. In FIG. 4, the front panel of the external housing of the generator has been removed to illustrate additional portions of the interior. In FIG. 5, the top panel of the external housing of the generator has been removed and an interior view of the top of the generator is illustrated. Hydrogen powered generator 305 includes a storage assembly 310, fuel cells 325 (325-1, 325-2, 325-3, and 325-4), one or more power converters 330, and output receptacles 335.

The storage assembly 310 comprises four stacks of hydrogen storage units 316, wherein each hydrogen storage unit 316 contains metal alloy material that absorbs and/or adsorbs hydrogen gas. In certain embodiments, one of the side panels or the top panel of the external housing of the generator can be opened to access the hydrogen storage units to facilitate maintenance or replacement of the storage units. In the example of generator 305, each of the hydrogen storage units 316 includes a coupler at the top of the unit through which hydrogen can be injected and released from the storage unit. In alternate embodiments, the hydrogen storage unit can have a coupler on the bottom as well as the top of the unit. As illustrated in FIGS. 4 and 5, each coupler at the tops of the hydrogen storage units 316 can be connected to a hydrogen conduit 318. One end of the hydrogen conduit 318 can be coupled to the fuel cell(s) 325 for supplying hydrogen to generate electricity. The opposite end of the hydrogen conduit 318 can be coupled to the hydrogen charging port 312 located on the external housing of the generator 305. The hydrogen charging port 312 allows pumping of new hydrogen gas into the storage units 316 when the storage units 316 have been depleted of hydrogen. In certain embodiments, a gauge can be located on the external housing of the generator to indicate the amount of hydrogen that is pumped into the storage units 316 and the amount of hydrogen that is depleted from the storage units 316. It should be understood that the configuration of the hydrogen storage units 316 and the hydrogen conduit 318 illustrated in FIGS. 3-5 is one example and in alternate embodiments these components can have other shapes and configurations.

FIGS. 4 and 5 also illustrate a vibration device 338 within the generator 305 and adjacent to the hydrogen storage units 316. The vibration device 338 can include a mechanical element that imparts either vibrational loading or percussive loading of hydrogen gas into gas storage units.

In one embodiment, the vibration device 338 can inject pressurized hydrogen gas into the hydrogen storage units 316. The pressurized hydrogen gas can be injected through a coupler on the hydrogen storage units 316. The pressurized hydrogen gas can be injected into the hydrogen storage units at a pressure ranging between 55 kPa (8 psi) and 2758 kPa (400 psi), or more narrow ranges therein including but not limited to 69 kPa (10 psi) to 2413 kPa (350 psi), or 276 kPa (40 psi) to 1388 kPa (200 psi).

In another embodiment, the vibration device 338 imparts a vibrational force to the hydrogen gas and to the metal alloy material within the storage units 316 when hydrogen gas is injected into the storage device during charging. The mechanical element of the vibration device 338 can provide an oscillating motion, examples of which include a solenoid, a microdrive, a vibration motor, a linear resonant actuator, a piezoelectric drive. Imparting a vibrational force to the metal alloy material during charging of the hydrogen storage unit 316 can increase the capacity of the metal alloy material to store hydrogen. Resonation of the metal alloy material can produce a super-saturation of hydrogen solubility in the metal alloy material, and in nickel or tin based metal alloys in particular. Additionally, in some examples, the frequency of the vibration device can be adjusted during charging of the storage device with hydrogen so that the frequency of the vibrational force approximates the resonant frequency of the metal alloy material.

In the example of FIGS. 4 and 5, the vibration device 338 is located external to each of the hydrogen storage units 316 and imparts force at the coupler attached to the external surface of each of the units. However, in other embodiments, the vibration device can be internal to the hydrogen storage unit.

Turning to the fuel cell(s) 325, as illustrated in FIGS. 4 and 5, they can be stacked adjacent to the hydrogen storage units 316. The fuel cell 325 combines the hydrogen from the storage units with oxygen to output electricity and water as is known to those in the field of hydrogen fuel cells. The fuel cell typically includes a delivery valve system controlling the flow of hydrogen into the fuel cell, a relief valve used in case of pressure build up, and a power controller that controls the raw power output from the fuel cell. The raw power generated by the fuel cells is in the form of a DC current. As one example, each fuel cell can generate 48 VDC of raw power. When the generator has multiple fuel cells, the raw power outputs of the fuel cells are configured in parallel so that one fuel cell can be taken off-line for maintenance or replacement while the other fuel cells and trays continue to delivery power.

The power converter 330 can receive the raw power from the fuel cell(s) 325 and convert it to an output power of the type needed by the equipment that is connected to the generator 305. As illustrated in FIG. 4, the power converter 330 can comprise a blade containing the appropriate power conversion components, such as one or more of transformers, inverters, and boost or buck converters, needed to convert the power from the fuel cells. In certain embodiments, the power converter 330 can comprise multiple blades, each of which provides a different output power to meet varying requirements. The blades can be configured so that they easily slide in and out of a front or side panel of the generator 305 so that they can be replaced with other blades providing other types of power when needed. The blades can be configured with contacts that connect to conductive tabs that electrically couple the blades to the fuel cells. The output power from the power converter 330 is made available at one or more output receptacles 335 located on the exterior of the generator 305.

With respect to the output power from the generator 305, each of the hydrogen storage units 316 can store 3-4 kilograms of hydrogen. Therefore, the 12 hydrogen storage units 316 within generator 305 can store 36 to 48 kilograms of hydrogen which equals 1,198 to 1,598 kW hours of storage capacity for the generator 305. Assuming the fuel cells 325 operate at 50% efficiency, the generator is capable of providing 599 to 799 kW hours of power. In some examples, the generators can be grouped or stacked to achieve larger amounts of total output power.

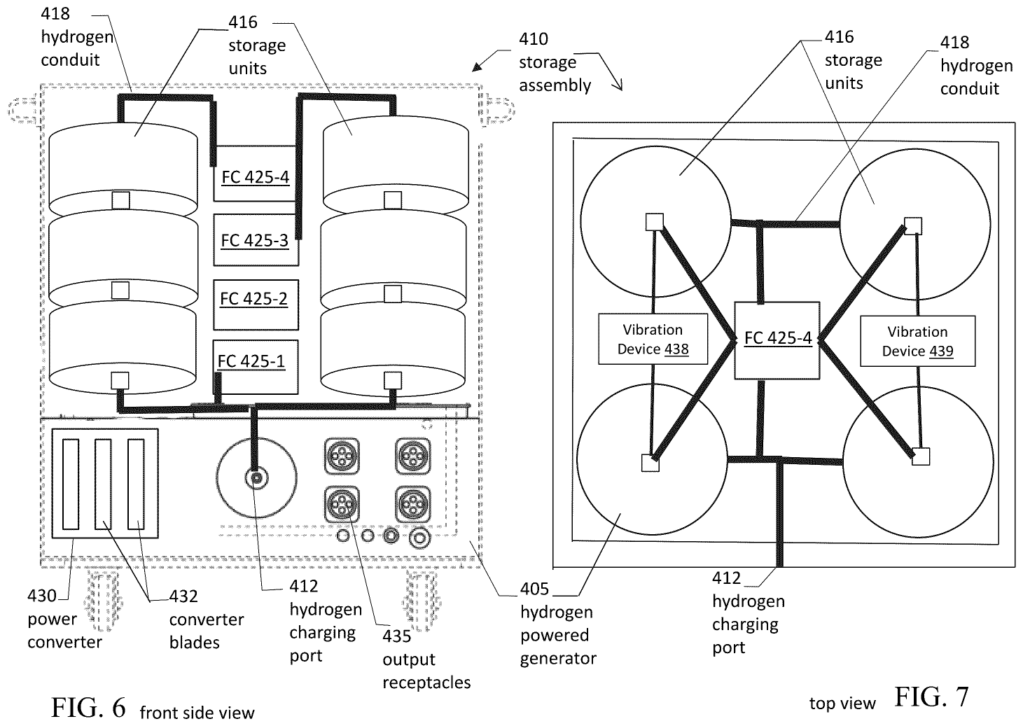

Referring now to FIGS. 6 and 7, another example embodiment of a hydrogen powered generator is illustrated. FIG. 6 illustrates interior components of hydrogen powered generator 405 after the front panel of the external housing has been removed. In FIG. 7, the top panel of the external housing has been removed to provide a top view of interior components of the hydrogen powered generator 405. Hydrogen powered generator 405 includes primary components that are similar to the components of the previously described example embodiments. For those components having the same last two digits in their reference number as a component reference number in the example of FIGS. 3-5, it should be assumed that the component in generator 405 is similar or equivalent to the component in generator 305 and a detailed description of that component will not be repeated.

Similar to hydrogen powered generator 305, hydrogen powered generator 405 includes a hydrogen charging port 412 that is used to inject hydrogen into hydrogen storage units 416 containing metal alloy material that absorbs and/or adsorbs hydrogen gas. The hydrogen is injected into the charging port 412, flows through hydrogen conduit 418, and enters the hydrogen storage units 416 through a coupler attached to each hydrogen storage unit. The hydrogen storage units 416 can have an inlet coupler for injecting hydrogen into the storage unit 416 and an outlet coupler for releasing hydrogen from the storage unit 416. Alternatively, the hydrogen storage unit 416 can be configured with a bi-directional coupler that allows hydrogen to flow into the storage unit 416 when charging and out of the storage unit when discharging hydrogen.

When power is needed, the hydrogen storage units 416 can supply hydrogen, via a coupler and the hydrogen conduit 418, to fuel cells 425-1, 425-2, 425-3, and 425-4, which combine the hydrogen with oxygen to generate electricity. The raw power output from the fuel cells is converted by the power converter 430 using one of the converter blades 432 to convert the electricity to a form (voltage, amperage, AC/DC) needed by the load. The power is output by the generator 405 at output receptacles 435. Generator 405 differs from generator 305 in that the fuel cells 425 are arranged in the center of the generator while the stacked hydrogen storage units 416 are located in each corner of the generator. As can be seen in the top view of FIG. 7, two vibration devices 438 and 439 can be used to impart a vibrational force at the coupler attached to each hydrogen storage unit 416 when charging them with hydrogen.

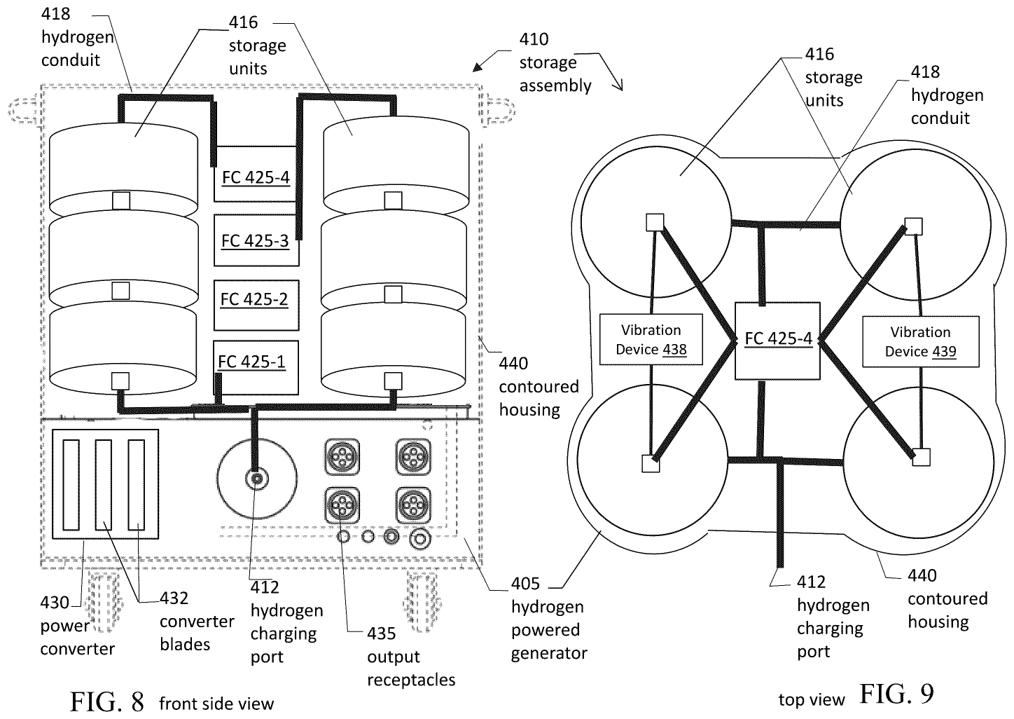

Referring now to FIGS. 8 and 9, another example embodiment of a hydrogen powered generator is illustrated. The example generator illustrated in FIGS. 8 and 9 is the same as the generator illustrated in FIGS. 6 and 7, except that the external housing of the generator has been modified. Specifically, the generator 405 illustrated in FIGS. 8 and 9 has a contoured external housing 440. As can be seen in the top view of FIG. 9, the corners of the contoured external housing 440 are rounded to correspond with the rounded shape of the stacked hydrogen storage units 416. The contoured external housing 440 can improve heat transfer between the external environment and the hydrogen storage units 416 which can improve the hydrogen storage capacity of the hydrogen storage units 416. The remaining components of the generator illustrated in FIGS. 8 and 9 are the same as the components illustrated and described in connection with FIGS. 6 and 7. Accordingly, a detailed description of those components will not be repeated.

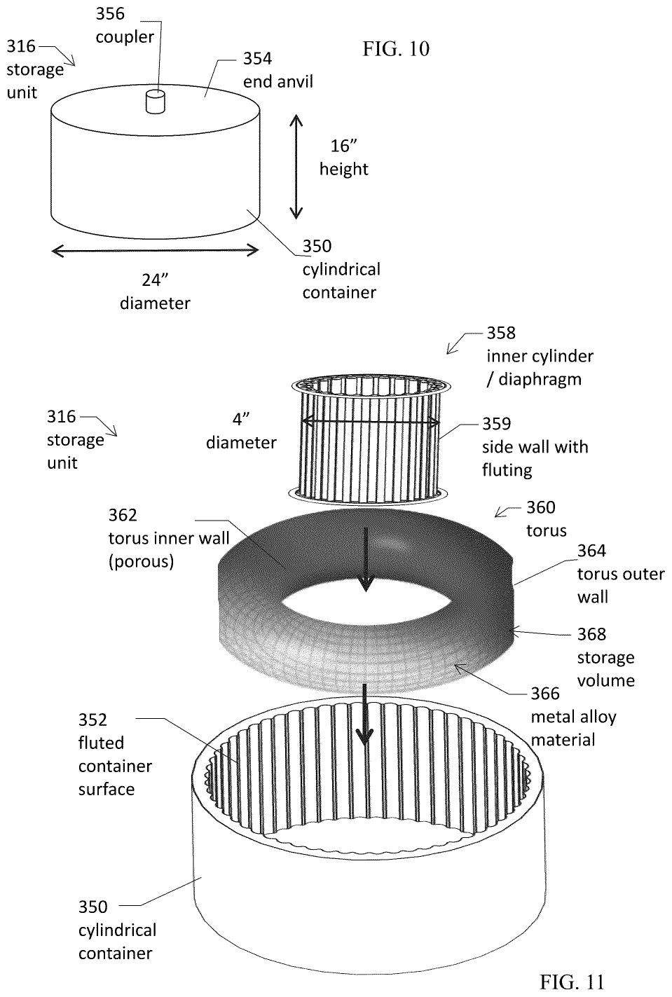

Referring now to FIGS. 10 and 11, the example hydrogen storage unit 316 will be described in greater detail. The details of hydrogen storage unit 316 are representative of the types of hydrogen storage units that can be used in any of the hydrogen storage generators described herein. Beginning with the external view of the hydrogen storage unit 316 in FIG. 10, the unit is cylindrical in shape having a height and a diameter. Typical dimensions for the height (16 inches) and diameter (24 inches) are shown in FIG. 10, however, it should be understood that other dimensions for the height and/or diameter are included within the scope of this disclosure. The proportions of the cylindrical shape illustrated in FIG. 10, namely the diameter is 1.5 times greater than the height, are preferred to optimize the performance of the hydrogen storage unit 316. One benefit of these proportions for the storage unit is that the relatively large surface area of the top and bottom surfaces of the unit improve heat transfer between the device and the environment which optimizes the capacity for storing hydrogen in the storage unit. Another benefit of these proportions is that it minimizes hydrogen reabsorption. Hydrogen reabsorption occurs during discharging of the storage unit wherein hydrogen gas is released from a portion of the metal alloy within the unit, but as the hydrogen gas travels towards the outlet valve of the unit, it is reabsorbed by another portion of metal alloy before reaching the outlet valve and thereby undermining the performance of the storage unit 316 and the generator. However, the proportions of the example storage unit 316 are optimized to address this problem in that the height is less than the diameter so that, during discharge, hydrogen released from the metal alloy will have a relatively short distance to travel to the outlet valve thereby reducing the likelihood of the hydrogen gas being reabsorbed by the metal alloy before reaching the outlet valve.

As illustrated in the external view of FIG. 10, the hydrogen storage unit 316 comprises a cylindrical container 350 which is enclosed on the top by a top end anvil 354 and which is enclosed on the bottom by a bottom end anvil similar to the top end anvil 354. When attached to the cylindrical container 350, the top end anvil 354 and bottom end anvil form a cylindrical cavity that can contain a metal alloy material capable of storing and releasing hydrogen gas. The top end anvil 354 has a top coupler 356 and the bottom end anvil has a similar bottom coupler (not visible in FIG. 10) that can connect the hydrogen storage unit 316 to the previously described hydrogen conduit, or to another storage unit, or to other appropriate equipment. The couplers can include a valve for controlling the flow of hydrogen into and out of the gas storage unit 316. The valves can be either unidirectional or bidirectional. As an example, when charging the hydrogen storage unit 316 with hydrogen, the hydrogen can be pumped into one or both of the top and bottom couplers at pressures ranging from 55 kPa (8 psi) to 2758 kPa (400 psi). One or both of the end anvils can be removably coupled to the cylindrical container 901 using fasteners such as bolts or other types of fastening devices. Additionally, the end anvils can include bumpers or other features that protect the gas storage unit 316 from impacts. The components of the hydrogen storage unit 316, including the cylindrical container 350, the end anvils, and the couplers can be made from any of a variety of metallic, polymer, or composite materials that are sufficiently durable to withstand the pressure cycling of charging and discharging hydrogen from the storage unit 316. Although the storage unit 316 is cylindrical with a generally circular shape when a cross-section is taken perpendicular to the central longitudinal axis in the example of FIG. 10, it should be understood that in alternate embodiments the storage unit can take other shapes such that the cross-section is elliptical or polygonal.

Referring now to FIG. 11, an exploded view of the example hydrogen storage unit 316 is shown. As illustrated, the cylindrical container 350 has a fluted container surface 352 on its interior. Within the cylindrical container 350 are an inner cylinder 358 and a torus 360. When assembled, the inner cylinder 358 is positioned at the center of the cylindrical container 350 thereby defining an annulus between the fluted container surface 352 and an outer surface of a side wall 359 of the inner cylinder 358. In certain embodiments, the inner cylinder 358 can attach to the inner surface of one or both of the top end anvil and the bottom end anvil when the storage unit 316 is assembled. In the example of FIG. 11, the side wall 359 of the inner cylinder 358 has a fluted outer surface similar to the fluted container surface of the cylindrical container 350 to improve thermal transfer. While other embodiments of the storage unit can have a smooth interior surface instead of the fluted container surface 352 and/or a smooth outer surface of the inner cylinder 358, the fluted surfaces can improve the performance of the storage unit in that the increased surface area increases thermal transfer between the storage unit and the external environment during charging and discharging of the storage unit. Additionally, when the surfaces are fluted, it should be understood that the fluting can take a variety of forms and shapes that optimize surface area for thermal transfer.

The material of the inner cylinder 358 can be an elastomer that flexes similar to a diaphragm as the storage unit 316 is charged with and discharges hydrogen. However, in other embodiments, the inner cylinder 358 can comprise a rigid material such as ceramic. The inner cylinder 358 can be permeable to hydrogen gas such that the hydrogen passes through inner cylinder 358 when charging or discharging the metal alloy material in the torus 360. Alternatively, the inner cylinder 358 can be impermeable to hydrogen gas and the hydrogen gas can pass into the metal alloy material through vents or other features. Lastly, a representative diameter of 4 inches for the inner cylinder 358 is shown in FIG. 11. In other embodiments this diameter of the inner cylinder 358 can be larger or smaller, however, it is generally preferred that the diameter not be larger than 4 inches in order to maximize the volume within the storage unit for storing hydrogen.

Referring to the torus 360, it is made of a flexible material that defines an inner storage volume 368 that contains metal alloy material 366. When the metal alloy material 366 absorbs hydrogen, it forms a metallic hydride. The metal alloy can comprise any combination of the following materials: nickel, tin, aluminum, manganese, iron, cobalt, copper, titanium, antimony, and rare earth metals such as yttrium, lanthanum, cerium, prascodymium, and neodymium. The metal alloy material 366 is typically a granular material that forms a porous composition and may include a binding agent. The metal alloy granules can have a D50 particle size from 1.0 microns, or 1.5 microns, or 2.0 microns to 2.5 microns, or 3.0 microns, or 4.0 microns, or 5.0 microns. In one example, the D50particle size of the metal alloy granules ranges from 1.5 microns to 2.0 microns. The term “D50” refers to the median diameter of the metal alloy granules such that 50% of the sample weight is above the stated particle diameter.

The torus 360 is intended to minimize leakage of the metal alloy material 366 from the storage unit 316. The torus 360 is made of a flexible material to accommodate expansion as the metal alloy material absorbs hydrogen. The flexibility of the torus 360 causes the torus inner wall to press against the outer surface of the inner cylinder 358 and the torus outer wall 364 to press against the inner surface (the fluted container wall 352) of the cylindrical container 350 to enhance thermal transfer. While the torus 360 is made of a flexible material, as illustrated in FIG. 11, the torus outer wall 364 can be formed to have a generally flattened surface to facilitate contact with the fluted container surface 352. The torus inner wall 362 can have pores through which hydrogen gas passes for charging and discharging of the storage unit 316. As one example, the torus inner wall 362 can comprise a metallic film containing pores that accommodate the flow of hydrogen.

With each charging and discharging of the gas storage unit, hydrogen can flow between one or both of the top and bottom couplers and the metal alloy material 366. Taking the charging of the storage unit 316 as an example, the hydrogen gas can enter through a valve in the top coupler 356, pass into the chamber in the interior of the inner cylinder 358, pass through the permeable material of the inner cylinder 358, and through the pores of the torus inner wall 362 where it is absorbed and/or adsorbed by the metal alloy material 366.

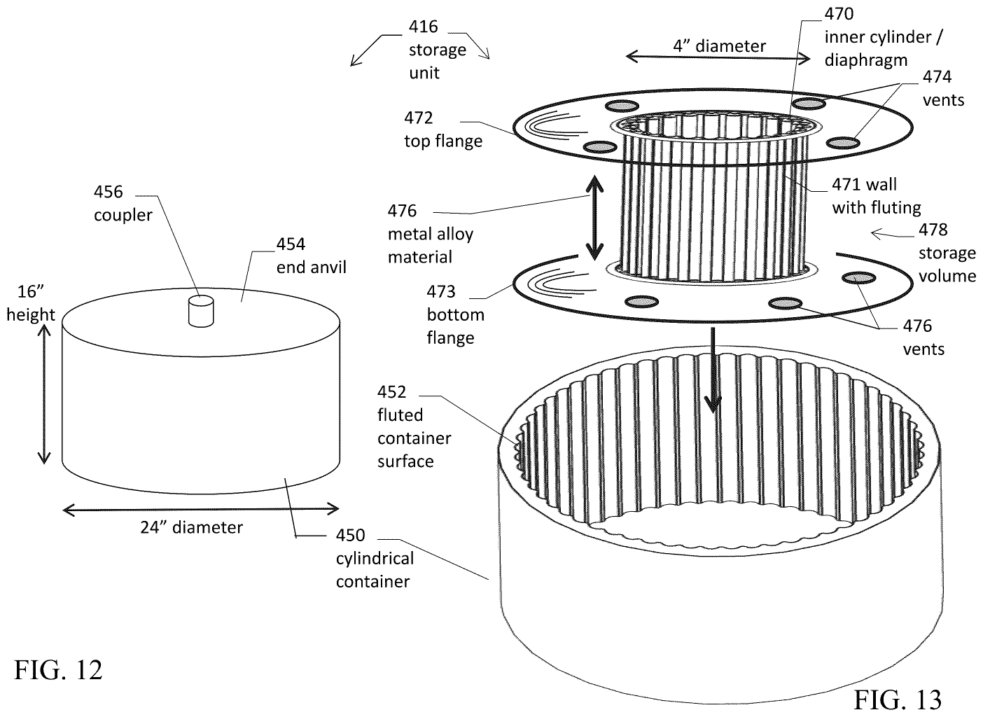

Referring now to FIGS. 12 and 13, another example of a hydrogen storage unit 416 is illustrated. Hydrogen storage unit 416 can be used in any of the example hydrogen powered generators described previously. The exterior of hydrogen storage unit 416 is similar to hydrogen storage unit 316 in that it comprises a cylindrical container 450, a top end anvil 454, and a bottom end anvil (not visible in FIG. 12) that together form an enclosed cylindrical volume for containing metal alloy material. Also similar to storage unit 316, storage unit 416 has proportions such that the diameter is greater than the height of the storage unit, preferably having proportions in which the diameter is 1.5 times greater than the height. The dimensions provided in FIG. 12 are examples and in other embodiments the diameter and height can have different dimensions while maintaining the same or approximately the same proportions. The storage unit 416 also includes a top coupler 456 and a bottom coupler (not visible in FIG. 12) that function in a manner similar to the previously described couplers.

Turning to FIG. 13, an exploded view is provided showing certain of the interior components of the hydrogen storage unit 416. The cylinder container 450 can have a fluted interior container surface 452 similar to cylinder container 350 of FIGS. 10 and 11. Additionally, the storage unit 416 has an inner cylinder 470 that is similar to the previously described inner cylinder 370. As in the previous example, the inner cylinder 470 has a side wall 471 that can include fluting on one or both of the exterior surface and the interior surface of the inner cylinder 470.

In one aspect, the interior of storage unit 416 differs from storage unit 316 in that it does not use the torus to contain the metal alloy material. Instead, the inner cylinder 470 has a top flange 472 and a bottom flange 473 that together with the inner cylinder 470 and the cylindrical container 450 define a storage volume that will contain the metal alloy material. The positioning of the metal alloy material is illustrated with reference number 476, but no metal alloy material is shown in FIG. 13 for the sake of simplifying the figure. The metal alloy material 476 is similar to the metal alloy material described previously herein.

The top flange 472 includes vents 474 and the bottom flange 473 includes vents 476. The vents allow hydrogen to flow to the metal alloy material 476 when the storage unit 416 is charging and allow hydrogen to exit the metal alloy material when the storage unit 416 is discharging. The vents 474 and 476 allow hydrogen to flow to the valves in the top coupler and the bottom coupler on the exterior of the hydrogen storage unit 416. Moreover, other example embodiments can include combinations of features of the foregoing examples, such as an embodiment that includes both a hydrogen permeable inner cylinder and vents so that there is more than one path for the hydrogen to flow into and out of the storage unit.

When absorbed by the metal alloy material, the hydrogen gas can be stored in a stable and secure manner. When discharging hydrogen from the storage unit, the hydrogen gas flows from the metal alloy material, through one of the previously described paths and into the diaphragm chamber from which it can exit through the valves in each coupler.

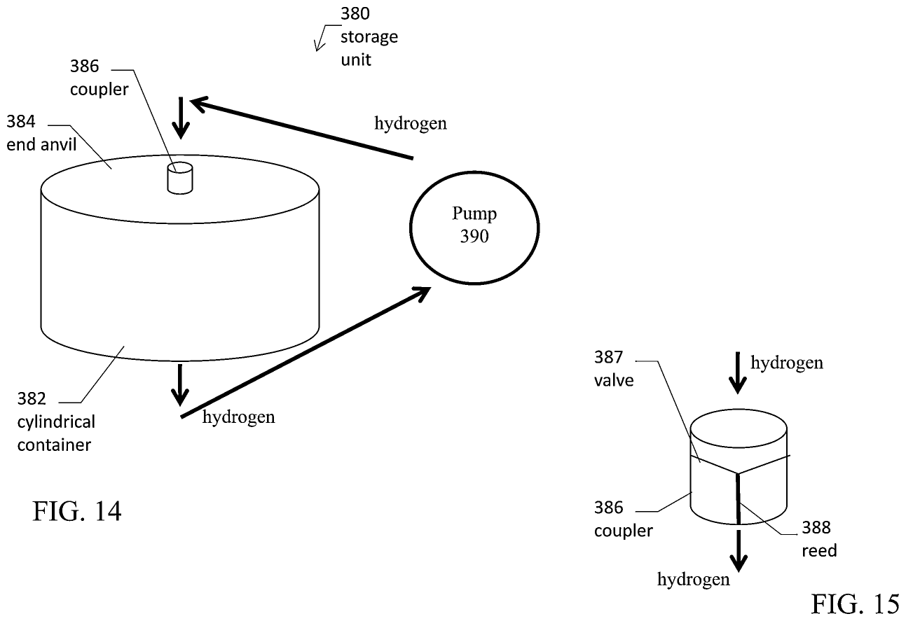

Referring now to FIGS. 14 and 15, another example embodiment for the previously described vibration device is illustrated. In contrast to the external vibration device described previously in connection with FIGS. 4-9, the vibration device of FIGS. 14 and 15 is a reed 388 that is mounted within the coupler of the storage unit. Hydrogen storage unit 380 is similar to the previously described storage units in that is has a cylindrical shape with a diameter that is larger than its height. Hydrogen storage unit 380 also comprises a cylindrical container 382, a top end anvil 384, a top coupler 386, and a bottom end anvil and bottom coupler (not visible in FIG. 14). FIG. 15 illustrates that the top coupler 386 includes a reed 388 along with the valve 387. As hydrogen flows through the top coupler 386 and the valve 387 into the storage unit 380, the reed will vibrate and impart a vibrational load to the metal alloy material within the storage unit 380. Accordingly, similar to the previously described vibration devices, the vibrations of the reed 388 can enhance the capacity of the metal alloy material to store hydrogen. In one application, the storage unit 380 with the reed 388 would be used in an arrangement where hydrogen is cycled through the storage unit 380 by a pump 390 while the storage unit 380 is charging so that the continuous flow of hydrogen causes the reed 388 to vibrate. In other embodiments, the vibration of the reed can be implemented with the storage unit in other arrangements.

Examples of suitable materials for the cylindrical container, the end anvils, and the couplers include metals, polymeric materials, nanomaterials, and combinations thereof. Examples of suitable metals include aluminum, aluminum alloys, copper, steel, and combinations thereof. Examples of suitable polymeric material for the cylinder include carbon fiber, polyolefin, polycarbonate, acrylate, fiberglass, Ultem, and combinations thereof. The cylindrical container and its components may be a combination of metal and polymeric material such as a metal liner thermoset in a polymeric resin, for example.

Materials for the storage unit that promote thermal conductivity may be preferred. The thermally conductive material promotes heat dissipation (cooling) during charging of the storage unit with hydrogen and promotes warming during discharging of hydrogen from the storage unit. In this way, the cylindrical container functions as a heat exchanger and the gas storage unit eliminates the need for a separate heat exchanger and/or a separate coolant system. The structure and composition of the gas storage unit advantageously promotes energy efficiency, case-of-use, case-of-production, and reduction in weight.

For any apparatus shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

Referring generally to the examples herein, any components of the apparatus described herein can be made from a single piece (e.g., as from a mold, injection mold, die cast, 3-D printing process, extrusion process, stamping process, or other prototype methods). In addition, or in the alternative, a component of the apparatus can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to couplings that are fixed, hinged, removeable, slidable, and threaded.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Although example embodiments are described herein, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A hydrogen powered generator comprising:
at least one fuel cell;
a power converter that receives a raw power from the at least one fuel cell and outputs a converted power; and
a hydrogen storage assembly that supplies hydrogen to the at least one fuel cell, the hydrogen storage assembly comprising a first hydrogen storage unit in fluid communication with the at least one fuel cell and a second hydrogen storage unit in fluid communication with the at least one fuel cell, wherein each of the first hydrogen storage unit and the second hydrogen storage unit comprise a torus containing a metal alloy material that absorbs and releases hydrogen gas.

2. The hydrogen powered generator of claim 1, wherein the first hydrogen storage unit and the second hydrogen storage unit are each cylindrical in shape having a height and a diameter, wherein the diameter is at least 1.5 times the height.

3. The hydrogen powered generator of claim 2, further comprising a housing having a base, a top, and at least one side wall, wherein the at least one side wall is contoured to correspond the cylindrical shape of the first hydrogen storage unit and the second hydrogen storage unit.

4. The hydrogen powered generator of claim 1, wherein the first hydrogen storage unit and the second hydrogen storage unit each comprise: an inner volume, wherein the metal alloy material within the torus fills 50% to 85% of the inner volume.

5. The hydrogen powered generator of claim 1, wherein the torus of the first hydrogen storage unit and the second hydrogen storage unit comprises a flexible material.

6. The hydrogen powered generator of claim 1, wherein the torus of the first hydrogen storage unit and the second hydrogen storage unit comprises an inner porous wall and an outer generally flat wall.

7. The hydrogen powered generator of claim 1, wherein the first hydrogen storage unit and the second hydrogen storage unit each have a coupler for injecting hydrogen into and releasing hydrogen from the first hydrogen storage unit and the second hydrogen storage unit.

8. The hydrogen powered generator of claim 7, further comprising a vibration device disposed in the coupler of each of the first hydrogen storage unit and the second hydrogen storage unit.

9. The hydrogen powered generator of claim 1, wherein the first hydrogen storage unit and the second hydrogen storage unit each comprise an inlet coupler and an outlet coupler at opposite ends of the first hydrogen storage unit and the second hydrogen storage unit, wherein the inlet coupler is connected to a hydrogen charging port and the outlet coupler is connected to the at least one fuel cell.

10. The hydrogen powered generator of claim 1, wherein the hydrogen storage assembly stores a quantity of hydrogen sufficient to output between 250 kilowatt hours and 2megawatt hours of energy.

11. A hydrogen powered generator comprising:
at least one fuel cell;
a power converter that receives a raw power from the at least one fuel cell and outputs a converted power; and
a hydrogen storage assembly that supplies hydrogen to the at least one fuel cell, the hydrogen storage assembly comprising a first hydrogen storage unit in fluid communication with the at least one fuel cell and a second hydrogen storage unit in fluid communication with the at least one fuel cell, wherein each of the first hydrogen storage unit and the second hydrogen storage unit comprise a storage volume defined by: an outer cylindrical container, an inner cylinder, a top flange attached to the inner cylinder, and a bottom flange attached to the inner cylinder, wherein the storage volume is configured to contain a metal alloy material that absorbs and releases hydrogen gas.

12. The hydrogen powered generator of claim 11, wherein the first hydrogen storage unit and the second hydrogen storage unit are each cylindrical in shape having a height and a diameter, wherein the diameter is at least 1.5 times the height.

13. The hydrogen powered generator of claim 12, further comprising a housing having a base, a top, and at least one side wall, wherein the at least one side wall is contoured to correspond the cylindrical shape of the first hydrogen storage unit and the second hydrogen storage unit.

14. The hydrogen powered generator of claim 11, wherein for each of the first hydrogen storage unit and the second hydrogen storage unit, wherein the metal alloy material fills 50% to 85% of the storage volume.

15. The hydrogen powered generator of claim 11, wherein the top flange and the bottom flange comprise vents through which the hydrogen gas passes.

16. The hydrogen powered generator of claim 11, wherein an outer surface of the inner cylinder is fluted and wherein an inner surface of the outer cylindrical container is fluted.

17. The hydrogen powered generator of claim 11, wherein the first hydrogen storage unit and the second hydrogen storage unit each have a coupler for injecting hydrogen into and releasing hydrogen from the first hydrogen storage unit and the second hydrogen storage unit.

18. The hydrogen powered generator of claim 17, further comprising a vibration device disposed in the coupler of each of the first hydrogen storage unit and the second hydrogen storage unit.

19. The hydrogen powered generator of claim 11, wherein the first hydrogen storage unit and the second hydrogen storage unit each comprise an inlet coupler and an outlet coupler at opposite ends of the first hydrogen storage unit and the second hydrogen storage unit, wherein the inlet coupler is connected to a hydrogen charging port and the outlet coupler is connected to the at least one fuel cell.

20. The hydrogen powered generator of claim 11, wherein the hydrogen storage assembly stores a quantity of hydrogen sufficient to output between 250 kilowatt hours and 2 megawatt hours of energy.
